(19) United States
(12) Patent Application Publication
(10) Pub. No.: US 2026/0198421 A1
(43) Pub. Date: Jul. 16, 2026

(54) HEADER ATTACHMENT SYSTEM FOR AGRICULTURAL VEHICLES

(71) Applicant: Deere & Company, Moline, IL (US)

(72) Inventors: Rana Shakti Singh, RAMGARH (IN); Scott N. Clark, Bettendorf, IA (US)

(21) Appl. No.: 18/947,622

(22) Filed: Nov. 14, 2024

(51) Int. Cl. A01D 41/127; A01B 69/04

(52) U.S. Cl. CPC A01D 41/1274; A01B 69/008

(57) ABSTRACT

An attachment system for coupling agricultural vehicles to attachments. The system can employ a machine learning model(s) to determine travel parameters that can guide the alignment of the agricultural vehicle and adjust an orientation of a connection interface of the agricultural vehicle as the agricultural vehicle moves between relative position thresholds. The travel parameters associated with different relative position thresholds can refine the movement of the agricultural vehicle as the agricultural vehicle comes into closer proximity to the attachment to assists in with precise alignment for the agricultural vehicle and associated connection interface with the attachment. The system can also utilize recorded location and actuator settings to assist in the attachment process. The system can also accommodate optional manual overrides for final positioning and coupling operations.

### FIELD OF THE DISCLOSURE

The present disclosure generally relates to attaching attachments to agricultural vehicles, and, more specifically, to an attachment system for at least partial automated alignment of at least a portion of an agricultural vehicle to an attachment during an attachment process.

### BACKGROUND

Agricultural vehicles, including, for example, combines, can be configured for selective coupling, including attachment to a removable attachment. For example, combines are designed to support headers that can be at least coupled, including directly or indirectly mounted, to a front of the combine. The particular attachment, including header, coupled to the agricultural vehicle can be changed or at least temporarily removed from the agricultural vehicle. For example, different types of attachments, including headers, can be selectively mounted to a combine for use with different types of crops an/or agricultural operations. After completion of an agricultural operation, such headers, among other types of attachments, can be decoupled, including detached, from the combine at a location at which the header may be stored or otherwise remain until later being recoupled to the combine during another, subsequent reattachment process. The storage location may be a permanent location, such as placed on the earth or a fixture, or it may be a temporary location, such as a portable trailer that can deliver the header to a desired location.

### SUMMARY

The present disclosure can comprise one or more of the following features and combinations thereof.

In one embodiment of the present disclosure, a method is provided for coupling an agricultural vehicle to an attachment. The method can include determining, by a controller, a first relative position threshold, a first travel parameter corresponding to a first guided movement to align the agricultural vehicle to the attachment. Additionally, the method can also include implementing, in response to a satisfaction of the first relative position threshold, the first travel parameter. The controller can also determine a second relative position threshold, a second travel parameter corresponding to a second guided movement to align the agricultural vehicle to the attachment. The second travel parameter can be different than the first travel parameter and further include an orientation parameter comprising one or more settings for an orientation of a first connection interface of the agricultural vehicle relative to a second connection interface of the attachment. Further, the second relative position threshold being different than the first relative position threshold. In response to a satisfaction of the second relative position threshold, the second travel parameter can be implemented. The implementation of the second travel parameter can include adjusting the orientation of the first connection interface based at least on the orientation parameter.

In one embodiment of the present disclosure, a method is provided for coupling an agricultural vehicle to an attachment. The method can include determining, by a controller, a travel parameter for each relative position threshold of a plurality of relative position thresholds. Each relative position threshold can correspond to a different relative position between the agricultural vehicle and the attachment. The travel parameter for one or more relative position thresholds of the plurality of relative position thresholds can be different than the travel parameter for at least another relative position threshold of the plurality of relative position thresholds. Further, the travel parameter for at least one relative position threshold of the plurality of relative position threshold can comprise an orientation of a first connection interface of the agricultural vehicle. In response to a satisfaction of a relative position threshold of the plurality of relative position thresholds, the travel parameter of the relative position threshold determined to be satisfied can be implemented. Further, the travel parameter for one or more relative position thresholds can refine the travel parameter for one or more other relative position thresholds that correspond larger variance in the relative positions of the agricultural vehicle and the attachment. The method can include, upon satisfaction of each different relative position threshold, the travel parameter for that completed relative position threshold. The method can further include adjusting the orientation of the first connection interface in response to the at least one relative position threshold being determined to be satisfied.

In another embodiment of the present disclosure, a system is provided for coupling an agricultural vehicle to an attachment. The system can include comprising an attachment actuator to adjust an orientation of a first connection interface of the agricultural vehicle, and a guidance system and a steering system, the steering system configured to execute a guidance directive determined by the guidance system. The system can further include a memory device that can be coupled to at least one processor. The memory device can include instructions that when executed by the at least one processor cause the system to determine, for a first relative position threshold, a first travel parameter corresponding to a first guided movement using the guidance system and the steering system to align the agricultural vehicle to the attachment, and implement, in response to a satisfaction of the first relative position threshold, the first travel parameter. The memory device can further include instructions that when executed by the at least one processor cause the system to determine, for a second relative position threshold, a second travel parameter corresponding to a second guided movement using the guidance system and the steering system to align the agricultural vehicle to the attachment. The second travel parameter can be a refinement of at least one parameter of the first travel parameter with respect to at least one of a value and a tolerance of the at least one parameter, and the second relative position threshold being different than the first relative position threshold. The memory device can further include instructions that when executed by the at least one processor cause the system to implement, in response to a satisfaction of the second relative position threshold, the second travel parameter, the implementation of the second travel parameter comprising an adjustment, using the attachment actuator, the orientation of the first connection interface relative to a second connection interface of the attachment.

These and other features of the present disclosure will become more apparent from the following description of the illustrative embodiments.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a top view of a simplified and exemplary representation of portions of an exemplary agricultural vehicle being aligned to be coupled to an attachment.

FIG. 2 illustrates a simplified block diagram of an attachment system for attachment of an attachment 2 to an agricultural vehicle.

FIG. 3 illustrates an exemplary representation of an agricultural vehicle being separated from an attachment by a plurality of relative position thresholds.

FIG. 4 illustrates a simplified exemplary representation of a method involving control logic for the attachment system in connection with aligning and attaching a first connection interface of the agricultural vehicle with a second connection interface of the attachment.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Attachments can be coupled to agricultural vehicles in a variety of manners, as well as at different locations relative to the agricultural vehicle. For example, certain attachments can be directly or indirectly cantilevered from a front portion or rear portion of the agricultural vehicle. Other attachments can include wheels or other ground engaging members, wherein the agricultural vehicle pushes or pulls the attachment. Additionally, the direct or indirect attachment, generally referred to herein collectively as an attachment, of the attachment to the agricultural vehicle can involve one or more connection points. For example, certain attachments can be attached to an agricultural vehicle via an engagement of a connection interface of the vehicle with a connection interface of the attachment at a single connection or attachment point, such as, for example, a hitch pin or ball hitch connection, while other attachments can involve one or more multiple connection interfaces and multiple connection points.

The difficulty of attaching an attachment to an agricultural vehicle can increase as the number of connection points increases. Such difficulty in attaining a secure connection, including mating engagement, between the connection interfaces of the attachment and the agricultural vehicle can further increase as the distance between connection points increases. For example, a connection interface of a header can have multiple connection points that are spread apart at different locations along a portion of a width of the header. While such distances between the connection points can, when the combine is attached to the header, be beneficial at least in terms of controlling the angle of the header relative to the combine, the distance between the connection points can also increase the difficulty of securely attaching the connection interfaces at each of those connection points. For example, when connecting a header to a combine, a connection between the connection interfaces of the header and combine can involve, upon connection, one or more header connection interfaces being accurately aligned with one or more connection interfaces of the header, including, for example, with respect to a parallel relationship between the connection interfaces. Such a parallel relationship can include, for example, the horizontal alignment, vertical height, pitch, yaw, and/or roll of the connection interfaces. Moreover, such proper alignment can include engaging the connection interfaces of the agricultural vehicle and attachment in a manner that prevents relative movement such as sliding or tilting, and which can allow, for certain connection interfaces, insertion of a pin(s) to securely couple the connection interfaces.

Achieving a parallel relationship between the connection interfaces of the agricultural vehicle and the attachment can be challenging for the operator operating the agricultural vehicle. In at least certain instances, attaining proper alignment between the connection interfaces of the agricultural vehicle and the attachment can be the product of a trial-and-error approach wherein the operator of the agricultural vehicle can make multiple attempts in attaining a proper alignment and subsequent connection between the connection interfaces. Such an approach however can reduce productive harvest time, potentially result in damage to one or both of the connection interfaces, and/or elevate operator stress.

Embodiments discussed herein provide an attachment system that can manage travel parameters, including one or more travel parameters relating to the positioning, speed control, and maneuvering of an agricultural vehicle and/or orientation of a connection interface of the agricultural vehicle for an attachment process. Additionally, such travel parameters can be automatically or semi-automatically implemented and/or output as suggested parameters during manual operation of the attachment process. Further, based on predefined settings, including, for example, settings provided by an operator, if any, default settings, tables or models, and/or derived by one or more machine learning models, the system can generate one or more travel parameters, that can be adjusted or changed as the relative positions of the agricultural vehicle and attachment changes, including in response to satisfaction of one or more relative position thresholds, which can be predetermined. According to certain embodiments, one or more travel parameters can be implemented, and adjusted, including with respect to the alignment of the agricultural vehicle and/or orientation of the first connection interface, until a particular relative position threshold is reached, at which, optionally, the operator can manually take over control to make the final adjustments to the agricultural vehicle and/or the connection interface of the agricultural vehicle. However, as discussed, with respect to such embodiments, one or more such final adjustments can be based on suggestions outputted by the system for the operator. Alternatively, rather than relying on operator control, such final adjustments can be determined and automatically implemented by the system, including with respect to the engagement of the connection interfaces of the agricultural vehicle and the attachment.

Therefore, according to certain embodiments, the system can at least initially target a connection interface or another portion of the attachment, such as, for example, a center frame of the attachment, in seeking to align the agricultural vehicle to the attachment. The system can further refine the alignment of the agricultural vehicle as the agricultural vehicle comes into closer proximity to the attachment, including, for example, with respect to a heading, speed of travel, and/or target location of/for the agricultural vehicle, or portions of the agricultural vehicle, including the connection interface.

Embodiments of the header attachment system discussed herein can provide a comprehensive solution for the precise and efficient coupling of agricultural vehicles to attachments, including the coupling of combines and headers. Moreover, the attachment system discussed herein can streamline the attachment process between connection interfaces of agricultural vehicles and attachments, thereby reducing operator intervention and minimizing trial-and-error approaches. The attachment system can also leverage a combination of sensor technologies, such as, for example, sensor information that can provide either or both geospatial and geographical information, and advanced algorithms, including machine learning models, to guide, align, and couple the agricultural vehicle to the attachment in an accurate and efficient manner. The increased efficiency that can be attained via the attachment system can at least be a factor in contributing to higher productivity in at least terms of usage of the attachment with the agricultural vehicle.

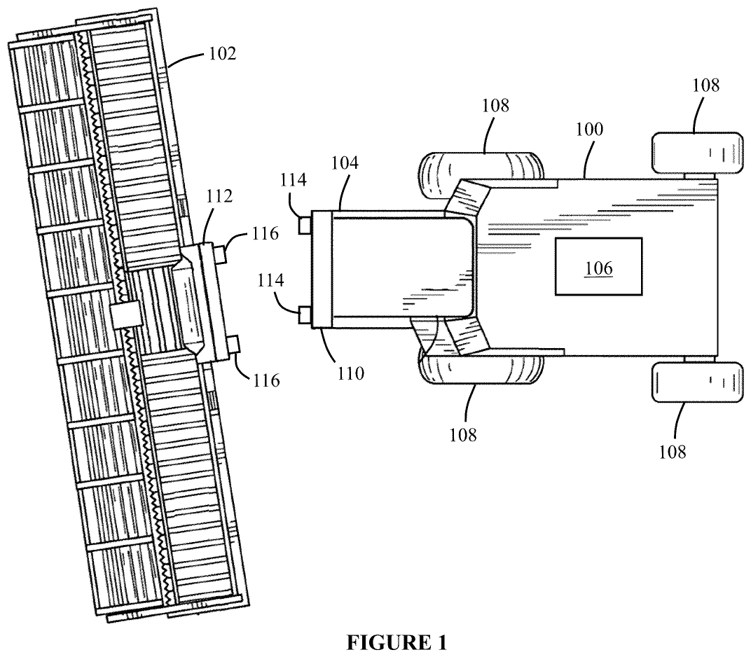

FIG. 1 illustrates a top view of a simplified and exemplary representation of portions of an exemplary agricultural vehicle 100 being aligned to be coupled to an attachment 102. A variety of different types of vehicles can be utilized as the agricultural vehicle 100, including, for example, combines, harvesters, windrowers, construction equipment, forestry equipment, and/or tractors, among other types of vehicles. Additionally, the agricultural vehicle 100 can be an autonomous, semi-autonomous, or manually operated vehicle, and can be supported by a plurality of ground engagement bodies 108, such as, for example, wheels and/or tracks.

A variety of different types of attachments can be utilized as the attachment 102 that is to be selectively, and removably, coupled to the agricultural vehicle 100. The type of attachments 102 that are to be coupled to the agricultural vehicle 100 can, for example, be based on the type of agricultural vehicle 100 and/or the type of agricultural, construction, and/or forestry operation that is to be performed using the attachment 102. For example, according to certain embodiments, the attachment 102 can be a corn header, draper header, grain header, auger header, flex header, pick up header, and/or sunflower header, among other types of headers and attachments. Accordingly, the agricultural vehicle 100 can be attached to a first attachment 102 for one operation, and be attached to another, such as, for example, a second or third attachment 102 for another operation.

In the exemplary embodiments shown in FIG. 1, the agricultural vehicle 100 is a combine that is coupled to a feeder house 104 that projects from a forward end of the combine. The feeder house 104 can receive crop material from the attachment 102 (e.g., header) and, in the illustrated example, rearwardly convey the received crop material to a threshing and cleaning system 106 of the combine. The threshing and cleaning system 106 can be configured to thresh and clean the crop gathered by the attachment 102. The threshing and cleaning system 106 can therefore, for example, include a rotor, a set of chaffers or sieves for separating the crop material to temporarily store the filtered crop material in a storage tank.

The agricultural vehicle 100 is configured for direct or indirect coupling to an attachment 102 via use of a first connection interface 110. For instance, in the illustrated example, shown in FIG. 1 in which a feeder house 104 is connected to the combine, a first connection interface 110 of the combine (e.g., agricultural vehicle 100) is located at the feeder house 104. Thus, with such an example, the attachment 102 (e.g., header) is indirectly coupled to the agricultural vehicle 100 (e.g., combine) via the feeder house 104. However, according to other embodiments, or other situations, the first connection interface 110 can be directly coupled to the agricultural vehicle 100 to accommodate direct coupling of the attachment 102 to the agricultural vehicle 100.

The first connection interface 110 of the agricultural vehicle 100 is configured for a releasable connection to a mating second connection interface 112 of the attachment 102. For example, the first connection interface 110 can include one or more connection interfaces 110 having one or more first connection points 114 positioned, including spaced, at different locations. The first connection points 114 can include, one or more hooks, clevises, bars, and/or attachment openings, as well as combinations thereof, among other types of connection points, that, when securely engaged with a mating second connection point(s) 116 of the second connection interface 112, can inhibit unintended or uncontrolled movement, including translation, pivoting or rotation, of the attachment 102 relative to the agricultural vehicle 100. Thus, the second connection point(s) 116 can be positioned, including spaced, along the second connection interface 112 in a configuration similar to that of the first connection points 114 along the first connection interface 110 such that the first and second connection points 114, 116 are aligned for a mating engagement at least when the first connection interface 110 is in proper, or correct, mating alignment with the second connection interface 112.

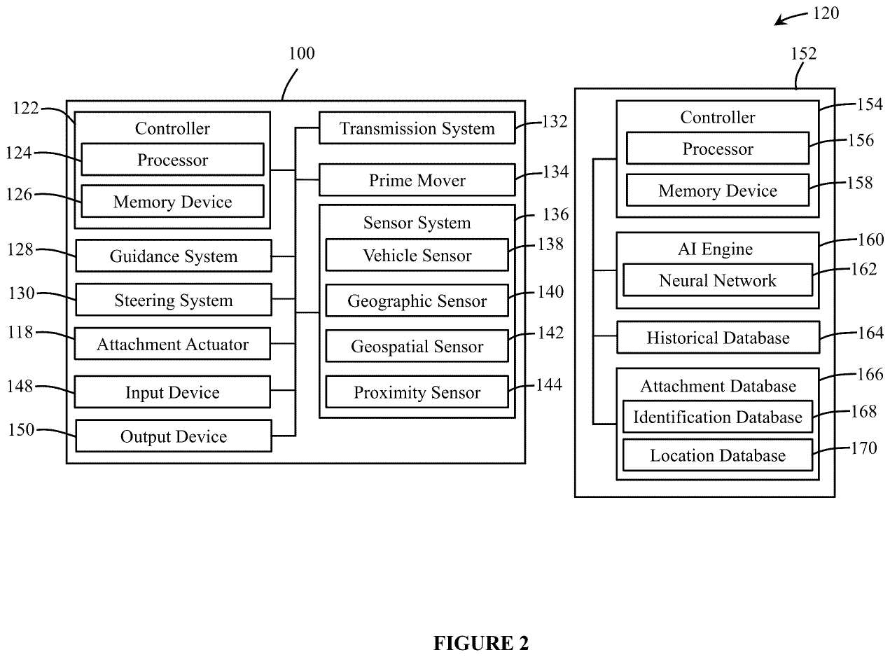

One or more attachment actuators 118 (FIG. 2) of the agricultural vehicle 100, including hydraulic actuators, pneumatic actuators, and/or electric motors, among others, can be utilized to adjust an orientation of the feeder house 104 and/or the first connection interface 110 in one or more directions relative to at least the attachment 102. Such adjustment in the orientation of the first connection interface 110 can include adjusting one or more of a position, height, tilt, pitch, roll, and/or yaw of the first connection interface 110 to align the first connection interface 110 with the second connection interface 112 and, moreover, align the connection points 114, 116 to facilitate coupling of the agricultural vehicle 100 to the attachment 102.

FIG. 2 illustrates a simplified block diagram of an attachment system 120 for attachment of an attachment 102 to an agricultural vehicle 100. As illustrated, the attachment system 120 can include the attachment 102, and, optionally, an offboard system 152. Additionally, the attachment system 120 can include one or more controllers 122, 154 that can be located at the agricultural vehicle 100 and/or the offboard system 152, among other locations. The controller(s) 122, 154 can have one or more processors and one or more memory devices 126, 148. The processors 124, 156 can be configured to follow instructions, including control instructions contained within, or that are part of, one or more of the memory devices 126, 148, including, for example, a non-transitory machine-readable medium.

The processors 124, 156 can be embodied as any type of processor or other compute circuit capable of performing various tasks. In some embodiments, each processor 124, 156 can be embodied as a single or multi-core processor, a microcontroller, or other processing or controlling circuit. Additionally, in some embodiments, each processor 124, 156 can be embodied as, include, or be coupled to an FPGA, an application specific integrated circuit (ASIC), reconfigurable hardware or hardware circuitry, or other specialized hardware to facilitate performance of the functions described herein. In some embodiments still, each processor 124, 156 can be embodied as a high-power processor, an accelerator co-processor, an FPGA, or a storage controller.

The memory devices 126, 148 can be of one or more types of non-transitory computer-readable media, such as a solid-state memory, electromagnetic memory, optical memory, or a combination thereof. Further, the memory devices 126, 148 can be volatile and/or nonvolatile. It should be appreciated that the memory devices 126, 148 can store information that is manipulated by the operating logic of processors 124, 156, such as, for example, information representative of inputted signals in addition to or in lieu of storing programming instructions defining operating logic. Each memory device 126, 148 can store various software and information used during operation of the attachment system 120, such as applications, programs, libraries, and drivers. Thus, the memory devices 126, 148 can include information, including algorithms and look-up tables, among other information, that can be used by the processor 124, 156, including with respect to features corresponding adjustments to the alignment of at least the agricultural vehicle 100, including the orientation, position, and/or speed, among other adjustments.

The attachment system 120 can include a sensor system 136, at least a portion of which can be positioned at the agricultural vehicle 100. The sensor system 136 can include one or more sensors, including, various different types of sensors, that can provide information regarding locations, spatial positioning, headings, orientations, and/or travel speeds of the agricultural vehicle 100 and/or attachment 102, as well as for various components thereof, in the first and/or second connection interfaces 110, 112, that can facilitate accurate alignment and coupling of the agricultural vehicle 100 with an attachment 102.

According to certain embodiments, the sensor system 136 can include one or more geospatial sensors 142, including sensors that can provide location information for at least the agricultural vehicle 100. For example, according to certain embodiments, the geospatial sensor 142 can include one or more location sensors or systems, including, for example, a global positioning satellite (GPS) system, among others. According to such an embodiment, the geospatial sensor 142 can include one or more sensors, including receivers, that can be positioned at the agricultural vehicle 100 that can receive information from a GPS satellite, among other information. For example, the geospatial sensor 142 can, according to certain embodiments, provide information identifying a coordinate information, such as, for example, in terms of latitude and longitude, of a current, past, and/or predicted location of at least the agricultural vehicle 100.

As discussed below, information provided by the geospatial sensor 142 of the agricultural vehicle 100, or of another agricultural vehicle, can be recorded in connection with a location at which the associated agricultural vehicle 100 detaches an attachment 102 from the agricultural vehicle 100. Such location information can further include, or be used to determine, the location of the agricultural vehicle 100 when the first and second connection interfaces 110, 112, including the connection points 114, 116, disengaged. According to such embodiments, when the agricultural vehicle 100, or another agricultural vehicle, is to again be coupled to the attachment 102, the particular location, including coordinates, of the agricultural vehicle 100 when the detachment between the agricultural vehicle 100 and the attachment 102 occurred can assist in guiding the current agricultural vehicle 100 to a location at which the agricultural vehicle 100 can be coupled to the attachment 102.

Additionally, or alternatively, the information provided by the geospatial sensor 142 when the agricultural vehicle 100 becomes detached from the attachment 102 can provide, or be used to determine, a location of the attachment 102. For example, information regarding the location of the first connection interface 110 relative to the geospatial sensor 102 of the agricultural vehicle 100 can, according to certain embodiments, be used to determine a corresponding location of the second connection interface 112 and/or of the attachment 102 at the time of detachment. As with other location information provided by the geospatial sensor 142, such location information regarding the detached attachment 102 can be used for guiding the agricultural vehicle and/or orienting the first connection interface 110 of the agricultural vehicle 100, or another agricultural vehicle, to the attachment 102.

Additionally, or alternatively, the sensor system 136 can include one or more geographic sensors 140. According to certain embodiments, the geographic sensor 140 can obtain information regarding the geographic characteristics of the area in which the agricultural vehicle 100 is situated, traveling along, and/or traveling towards. Such geographic information can include, for example, terrain information, including terrain elevation, pitch, and/or slope. Additionally, or alternatively, the geographic sensor 140 can include more sensors that can indicate an orientation of the agricultural vehicle 100, or portions thereof, including, for example, the first connection interface 110, at least relative to the adjacent and/or upcoming terrain. For example, according to certain embodiments, the geographic sensor 140 can include an accelerometer and/or a gyroscope that can provide information regarding the height, tilt, pitch, roll, and/or yaw of the agricultural vehicle 100 and/or portions thereof, including, for example, the first connection interface 110. According to certain embodiments, when the agricultural vehicle 100, or another agricultural vehicle, decouples from the attachment 102, information provided by the geographic sensor 140, including, for example, information regarding height, tilt, pitch, roll, and/or yaw of at least a portion of the agricultural vehicle 100, including, for example, the first connection interface 110, at the time of detachment can be recorded. Such recorded information, which can provide an identification of the orientation of the first connection interface 110 when coupled or decoupled from the second connection interface 112, can subsequently be retrieved to assist in later attaching the attachment 102 to the agricultural vehicle 100 or to another vehicle.

According to certain embodiments, the geographic sensor 140 can provide information regarding, or used by the controller 202 to determine, an orientation of the attachment 102, or portions thereof, including the second connection interface 112, at least when the attachment 102 was detached from the agricultural vehicle 100. Further, such information can also be utilized to identify represent a current orientation of the detached attachment 102. For example, according to certain embodiments, information provided by the geographic sensor 140 can provide information regarding the tilt, pitch, roll, and/or yaw of the attachment 102, or portion thereof, including the second connection interface 112, as the detached attachment 102 is positioned on a ground surface, trailer, or support structure, among other locations. Additionally, information provided by the geographic sensor 140 can provide information regarding a vertical height at which the attachment 102 was positioned at least at the time of detachment of the attachment 102 from the agricultural vehicle 100. Such a vertical height, which can also be used to identify a current vertical height of the detached attachment 102 can, for example, correspond to a vertical position at which the attachment 102 is currently positioned on the grass, a trailer, or other structure.

The sensor system 136 can also, according to certain embodiments, include one or more proximity sensors 144 that can provide information the controller 122 can use to relatively precisely determine a position or distance of the attachment 102, or portion thereof, including the second connection interface 112, relative to/from the agricultural vehicle 100, or a portion thereof, including, for example, the first connection interface 110. A variety of different types, or combinations of types, of sensors can be utilized for the proximity sensor 144. For example, according to certain embodiments, the proximity sensor 144 can include a capacitance sensor that can provide information, such as information regarding a change in capacity, that can be used to determine the proximity of the agricultural vehicle 100, or portions thereof, including, for example, the first connection interface 110, to the attachment 102, or portions thereof, such as, for example, the second connection interface 112. Additionally, or alternatively, the proximity sensor 144 can include one or more distance perception sensors, including, for example, optical or vision sensors, among others. A variety of different types of distance perception sensors can be utilized, including, but not limited to, stereo depth cameras, stereo sensors, RGBD (red, green, blue, depth) cameras, three-dimensional sensors, LIDAR, radar, and three-dimensional cameras, as well as combinations thereof, among other types of distance perception sensors. Additionally, according to certain embodiments, the distance perception sensor(s) can be part of an optical recognition system that can be included with the agricultural vehicle 100 and/or otherwise communicatively coupled to the controller 122.

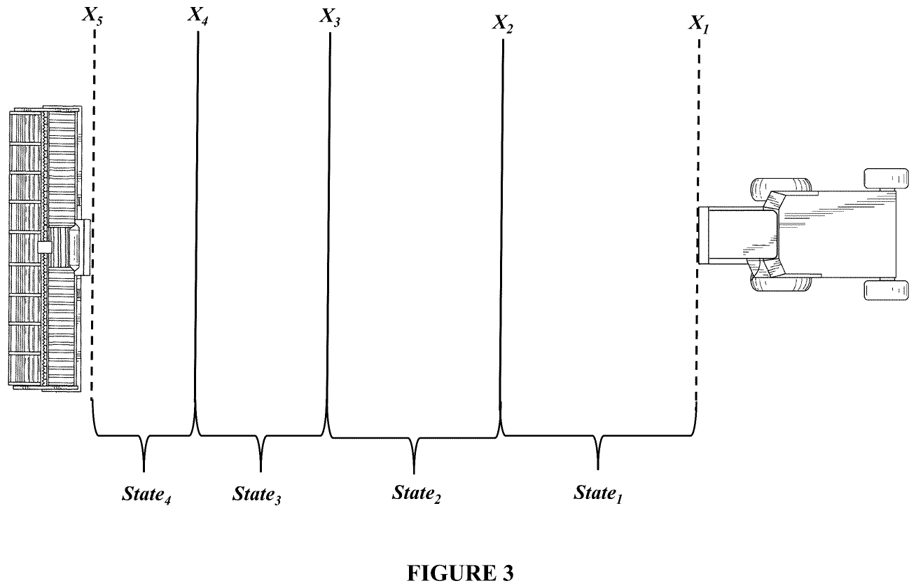

The sensor system 136 can also include one or more vehicle sensors 138 that can provide information regarding the travel, movement, or motion of the agricultural vehicle 100. For example, the sensor system 108 can include one or more vehicle sensors 138 that can provide information regarding either, or both, a speed or heading at which the agricultural vehicle 100 is traveling. Additionally, according to certain embodiments, the heading of the agricultural vehicle 100 can be indicated by the vehicle sensor 138 in the form of a transmission sensor that can provide an indication of whether a transmission system 132 of the agricultural vehicle 100 is engaged for the agricultural vehicle 100 to move in a forward, or reverse, heading. As discussed below, information provided by at least the vehicle sensor 138 can, for example, be utilized by the controller 122 to proactively determine, including estimate or predict, when the agricultural vehicle 100 will be at or within certain predetermined relative position thresholds from the attachment 102. Such a determination by the controller 122 can be utilized to determine when the agricultural vehicle 100 should begin adjusting and/or implementing certain determined travel parameters and/or transitioning from one travel state to another travel state (e.g., FIG. 3) based on a particular relative position, including, but not limited to, a predetermined distance, between the agricultural vehicle 100 and the attachment 102.

As also seen in FIG. 2, the attachment system 120 can, according to certain embodiments, also utilize either or both a guidance system 128 and a steering system 130 of the agricultural vehicle 100 in attaining an accurate alignment of the agricultural vehicle 100 and the attachment 102 during the attachment process. The steering system 130 can be configured to execute navigational or guidance directives determined by the guidance system 128, including adjust a steering mechanism(s) of the agricultural vehicle 100 in a manner that can alter the angular orientation of at least some of the ground engagement bodies 108 to align the agricultural vehicle 100 with a guidance path derived by the guidance system 128. As discussed below, the attachment system 120 can utilize a variety of different types of information in connection with one or more signals generated by the controller 122 and/or information from the sensor system 136 to dynamically adjust a path of travel of the agricultural vehicle 100 based at least on changes in the relative positions, including, for example, distance, between the agricultural vehicle 100 and the attachment 102, as well as in view of operator preferences, if any. For example, the controller 102 can be configured to utilize one or more tables, databases, operator settings, or algorithms, including one or more machine learning models, including algorithms, developed by a neural network 162 of an artificial intelligence (AI) engine 160 in addition to, or in lieu of, information from the sensor system 136, among other inputs, to dynamically adjust a path of travel of the agricultural vehicle 100. These adjustments can involve, as variances, including, but not limited to, distances, in the relative positions of the agricultural vehicle 100 and the attachment 102 decreases, fine corrections in steering angles and the orientation of the agricultural vehicle 100 to relatively precisely align the agricultural vehicle 100, or portion thereof, such as, for example, the first connection interface 110 with the attachment 102, or portions thereof, such as, for example, the second connection interface 112.

In at least certain situations, the location at which the agricultural vehicle 100, or another vehicle, last decoupled from the attachment 102, as can be indicated, for example, by coordinate information provided by the geospatial sensor 142, can be recorded, including stored, such as, for example, at a memory device 126, 158 and/or a database 166, 170. In such situations, the guidance system 128 can retrieve, or otherwise receive, the recorded location and use current location information for the agricultural vehicle 100, as can be provided by the geospatial sensor 142, to compare the retrieved recoded last location and the current position of the agricultural vehicle 100 to guide, or otherwise determine a path of, travel of the agricultural vehicle 100 to the attachment 102, and, moreover, to the recorded location. In certain situations, such travel to the attachment 102 by the agricultural vehicle 100 can be automated such that at least guidance information provided by the guidance system 128 can be used to operate the steering system 130 in directing or steering the movement of the agricultural vehicle 100.

In other instances, in which the information regarding the location at which the agricultural vehicle 100, or another vehicle, last decoupled, including detached, from the attachment 102 was not recorded, or the attachment 102 was subsequently moved to another, unrecorded location, the attachment system 120 can utilize one or more of the proximity sensors 144 to detect and/or identify the attachment 102. According to such situations, the guidance system 128 and/or controller 122 can use information provided by the proximity sensor(s) 144 to guide a travel of the agricultural vehicle 100 to the attachment 102.

In addition to at least the guidance system 128 utilizing information provided by either or both geospatial sensor 140 and the proximity sensor 144, the guidance system 128 can also utilize information provided by the geographic sensor 140. For example, while the geospatial sensor 142 can provide location information in accordance with a coordinate system, among other types of location information, the geographic sensor 140, alone or in combination with information from the proximity sensor 144, can provide information for fine-tuned navigation and precise positioning of the agricultural vehicle 100. For example, as discussed above, the geographic sensor 140 can provide terrain information that can account for the terrain on which the agricultural vehicle 100 is currently, and/or will be, traveling, that can account for local variables such as, for example, local terrain elevations and slopes, among other variables.

As also indicated by FIG. 2, the attachment system 120 can utilize either or both the transmission system 132 and a prime mover 134, including an engine, of the agricultural vehicle 100 to modulate a speed of travel, and, if necessary, a heading, of the agricultural vehicle 100. Generally, the transmission system 132 is configured to transmit a force generated by the prime mover 134 to propel the movement or travel of the agricultural vehicle 100. As discussed below, the attachment system 120 can be configured for the controller 122 to generate one or more signals based on determinations made using, for example, one or more of a lookup table, database, operator preference, and/or algorithms, including a machine learning model(s) provided by the neural network 162, among other inputs or sources of information, to make adjustments in the operation of either or both the transmission system 132 and the prime mover 134 that adjust, for example, the speed of travel of the agricultural vehicle 100 based at least on identified changes in the relative positions of the agricultural vehicle 100 and the attachment 102.

The attachment system 120 can also include an input device 148 and an output device 150 of the agricultural vehicle 100. The input and output devices 148, 150 can be located at the agricultural vehicle 100, or be remotely located from the agricultural vehicle 100, including, for example, with respect to autonomous or semi-autonomous agricultural vehicles 100. A variety of different types of devices can be utilized for the input and output devices 148, 150. Additionally, according to certain embodiments, the input and output devices 148, 150, can be part of the same device (e.g., an input/output (I/O) device). The input device 148 can provide an interface for the operator of the agricultural vehicle 100 to input commands or other information that are to be communicated to at least the controller 122, including, but not limited to, via use of a graphical user interface (GUI). For example, according to certain embodiments, the input device 148 can include one or more of a keyboard, touch screen, microphone, joystick, switch, and/or button, among other devices. The output device 150 can provide an interface for information to be communicated from at least the controller 122 to the operator. Thus, the output device 150 can include, for example, one or more of a display, screen, touch screen, speaker, light, and/or haptic device.

According to certain embodiments, the attachment system 120 can include an offboard system 152. The offboard system 152 can have a variety of different configurations, including, for example, be a cloud-based server, remote database, and/or a central system, among other configurations. Further, as indicated above, the offboard system 152 can include a controller 156 having at least one processor 156 and at least one memory device 158 that can be generally similar to the corresponding controller 122, processor(s) 124, and memory device(s) 126 discussed above with respect to the agricultural vehicle 100. Additionally, the controller 156 of the offboard system 152 can be communicatively coupled to the controller 122 of the agricultural vehicle 100, including, for example, via a wired and/or a wireless connection. For example, according to certain embodiments, communications can be exchanged between the controller 156 of the offboard system 152 and the controller 122 of the agricultural vehicle 100 via a wireless connection over a network.

The offboard system 152 can include an artificial intelligence (AI) engine 160 that can include a neural network 162. By being at the offboard system 152, information collected by a plurality of agricultural vehicles can be used to train, and retrain, one or more machine learning models, including algorithms, of the neural network 162. According to certain embodiments, the machine learning model(s), and, optionally, updates to such models, can be communicated to the controller 122 of the agricultural vehicle 100, and stored at the agricultural vehicle 100, including by the memory device 126. Alternatively, or additionally, the AI engine 160 and neural network 162 can be located at the agricultural vehicle 100 and communicatively coupled to the controller 122.

The neural network 162 can employ machine learning models, including algorithms, designed to enhance the precision and efficiency of the attachment process for coupling the agricultural vehicle 100 to the attachment 102. As discussed below, such machine learning models can be used to determine and/or adjust one or more travel parameters as a relative position or travel state of the agricultural vehicle 100 changes. Further, one or more relative position threshold(s), which can, for example, correspond to different distances and/or different relative positioning between the agricultural vehicle 100 and the attachment 102, can, according to certain embodiments, also be determined via use of the machine learning model(s). Additionally, or alternatively, the relative position thresholds can be based on operator preferences, or derived by the machine learning model(s) in view of operator preferences. According to another embodiment, such relative position thresholds can correspond to default settings.

According to certain embodiments, the architecture of the neural network 162 can include one or more input layers that can process raw information, including data, from one or more sensors 138, 140, 142, 144, 146 of the sensor system 136 and identified operator preferences, among other information. The neural network 162 can further comprise multiple hidden layers of interconnected neurons that can process inputted information, such as input data, including applying nonlinear transformations to extract complex patterns and relationships within the information. For example, the hidden layers can employ activation functions to introduce non-linearity and improve the ability of the neural network 162 to model intricate dependencies. The neural network 162 can further include an output layer that can generate information for guiding, and/or adjusting, one or more of the position, orientation, and speed of the agricultural vehicle 100, among other travel parameters, and/or an identification of the relative position thresholds in connection with aligning the agricultural vehicle 100, or portion thereof, such as the first interface connection 110, with the attachment 102, or portion thereof, such as the second interface connection 112. Adjustments in the travel parameters can be in response to changes in the relative positions, including, for example, distance, orientation, and/or alignment, between the agricultural vehicle 100 and the attachment 102, including as the agricultural vehicle 100 is moving and reaches different identified relative position thresholds, as discussed below.

The machine learning model(s) of the neural network 162 can be trained, and/or retrained, in a variety of manners, including, for example, via supervised learning, adaptive learning, and/or generative models. For example, with respect to supervised learning, historical information, as can be stored in a historical database 164, can include labeled examples of prior attachment processes that at least attempted to successfully couple the agricultural vehicle 100 to the attachment 102, and can utilize, for example, optimization models, such as, for example, Gradient Descent or Adam Optimizer, for minimizing the error between predicted and actual outcomes. With respect to adaptive learning, the neural network 162 can, for example, continue to learn adaptively from at least near real-time information, including, for example, information provided by one or more sensors 138, 140, 142, 144, 146 of the sensor system 136, and refine the accuracy or efficiency of the machine learning model via updating applied weights based on feedback information. With respect to generative machine learning models, the neural network 162 can, for example, simulate various attachment processes coupling the agricultural vehicle 100 to the attachment 102, including the first connection interface 110 to the second connection interface 112, based on existing data to forecast potential difficulties, and devise strategies to mitigate those difficulties.

The controller 102, including, for example, via use of the machine learning model of the neural network 162, among other sources of information, can also be configured to, as the position of the agricultural vehicle 100 relative to the attachment 102 changes, including, for example, a distance therebetween decreases, and/or the agricultural vehicle passes certain relative position thresholds / operates in certain travel states, be used to dynamically correct errors in alignment. Such dynamic error corrections can include, for example, adjusting one or more angular orientations of the agricultural vehicle 100, or portions thereof, including the first connection interface 110 relative to known or predicted corresponding angular orientations of the attachment 102, or portions thereof, including, for example, the second connection interface 112. Such error correction can, for example, be based on a detected or predictive relative alignment of the agricultural vehicle 100 and the attachment 102, or portions thereof, including the first and second connection interfaces 110, 112, being identified as not satisfying a corresponding predefined tolerance level. Such satisfaction of predefined tolerance levels can be determined in a variety of manners, including, for example, comparing alignment feedback information, including angular or orientation information, that can be obtained, or derived by the controller 122 using information, from one or more sensors 138, 140, 142, 144, 146 of the sensor system 136 to the corresponding actual relative alignments of the agricultural vehicle 100 and the attachment 102, including portions thereof, such as the first and second connection interfaces 110, 112. Such systematic fine-tuning can reduce the margin of error with respect to the relative alignments of the agricultural vehicle 100 and the attachment 102, particularly when the first connection interface 110 is at, or is close to, a position for mating engagement with the second connection interface 112.

Additionally, the neural network 162 can be configured to align the strategies for alignment of the agricultural vehicle 100 that are being sought to be attained from the information provided from the machine learning model(s) with operator preferences by learning and adapting the machine learning model(s) to specific operator control inputs and manual interventions that can be preset by the operator and/or recorded during other, including previous, attachment processes. Such an approach can at least assist in facilitating a semi-autonomous mode that can blend the automated precision being sought by the machine learning model(s) with operator expertise.

The offboard system 152 can include a plurality of databases 164, 166, 168, 170 that can store a variety of different types of historical, operator preference, and/or identification information that can be used in the training, or retraining, of the machine learning model(s) of the neural network 162. For example, the offboard system 152 can include a historical database 164 that can store information regarding past commands generated by a machine learning model(s) of the neural network 162 in connection with prior attachment processes. For example, the historical database 164 can include information regarding past commands that involved adjusting one or more travel parameters, including, for example, the speed, orientation, and/or heading of the agricultural vehicle 100 as the relative positions, including distance, between the agricultural vehicle 100 and the attachment 102 changed, and/or as relative position thresholds were satisfied, in at least an attempt to facilitate relatively precise alignment of the agricultural vehicle 100 to the attachment 102, and, moreover associated aligning the first interface connection 110 with the second interface connection 112. Thus, the historical database 164 can also include, among other types of information, records of past specific adjustments made to the speed, orientation, and/or heading of the agricultural vehicle 100, among other travel parameters, during the attachment process based on one or more determinations outputted by the machine learning model(s) of the neural network 162.

The historical database 164 can also include feedback information relating to prior attachment processes that utilized one or more determinations based on an output from the machine learning model of the neural network 162. Such feedback information can include, for example, information obtained from one or more sensors of the sensor system 136 during previous coupling operations, including measurements of distance between the agricultural vehicle 100 and the attachments 102, actual speeds of the agricultural vehicle 100, and/or identified alignment parameters (e.g., horizontal and vertical positioning) and orientation angles (e.g., approach or steering angles, height, tilt, pitch, yaw, and/or roll) as can be provided by the geospatial sensor 142. The feedback information can also include adjustments made by the operator, or other systems, to one or more operations of the agricultural vehicle 100 that had been based on information from the machine learning model of the neural network 162, as well as other potential variables that can be present in connection with those operator initiated adjustments, including, for example, terrain information, as can be indicated by information from the geographic sensor 140, among other variables.

The feedback information stored by the historical database 164 can also include performance metrics that can provide an indication of the success, or lack thereof, of past coupling operations, including, with respect, to the time and/or number of attempts taken to achieve alignment between the agricultural vehicle 100 and the attachment 102, or portions thereof, including the first and second connection interfaces 110, 112, number, types, and/or extent of adjustments required, including with respect to the attachment actuator 118, and instances of operator intervention.

The historical database 164 can also include ancillary information that can impact the agricultural vehicle 100 when being moved into alignment with the attachment 102. For example, such ancillary information can include information regarding environmental conditions during past operations, such as, for example, the pitch/roll and/or downward pressure of the attachment 102 (e.g., header), feederhouse tilt, fore/aft position of the feeder house 104, a gage wheel position, soil moisture content and/or precipitation levels, among other information, that can impact the interaction of the ground engagement bodies 108 with the ground that can impact the performance or operation of the guidance, steering, and/or transmission systems 128, 130, 132, including, for example, influence the turning, stopping, and/or speed adjustments of the agricultural vehicle 100.

Information provided by the historical database 164 can enable the neural network 162 to leverage past attachment operations to optimize future attachment operations, including optimizing the travel parameters associated with different relative position thresholds. By analyzing patterns identified by the neural network 162 from at least the information stored by the historical database 164, among other information, the neural network 162 can refine the machine learning model(s) to enhance predictive accuracy and improve the efficiency of the attachment process, including with respect to the travel parameters obtained via use of the machine learning model(s) for different travel states, as discussed above. The historical database 164 can also support the above-discussed adaptive learning by allowing the neural network 162 to update its models in real-time based on information collected, for example, from the at least one or more sensors 138, 140, 142, 144, 146 of the sensor system 136 and/or from operator inputs via the input device 148 during ongoing operations. Such a continuous learning process can assist the alignment being attained by the agricultural vehicle 100 during the alignment process being adapted to varying conditions and operator preferences.

The offboard system 152 can also include one or more databases, such as, for example, an attachment database 166, that can include various information regarding at least the attachment 102, among other attachments, that is to be involved in a current or upcoming attachment process. The particular attachment 102 for which information stored in the attachment database 166 is to be retrieved, and/or used, in connection with an attachment process, including a current or upcoming attachment process, can be identified in a variety of manners. For example, according to certain embodiments, an attachment 102 that is, or will be, involved in the attachment process, and for which information is to be retrieved, can be identified via an operator inputting one or more identifiers for the attachment 102 via use of the input device 148. Additionally, according to certain embodiments, one or more of the proximity sensors 144 can capture information, including images, from which unique features of the attachment 102 can be extracted. Such extracted information can include identification codes, symbols, or tags, and/or involve the controller 122, 154 analyzing a corresponding shape and/or size of the attachment 102, or portion thereof, from the captured information.

The attachment database 166 can store a diverse range of information regarding different attachments 102 that can facilitate an attachment process for the identified attachment. For example, the attachment database 166, including an identification database 168, can store an identification of the attachment type, such as, for example, a header type, and at least certain physical dimensions of the attachment 102. Such dimensions can include, for example, information regarding the location, orientation, spacing, of the second connection interface 112 and/or the associated second connection points 114 of an identified attachment 102.

The attachment database 166, including a location database 170, can store information regarding the recorded location of the attachment 102, including information recorded from the geospatial sensor 142 when the attachment 102 was last decoupled from the agricultural vehicle 100 or from another vehicle. Moreover, the location database 170 can include, for example, coordinates (e.g., latitude and longitude), among other location information, of the attachment 102 and/or agricultural vehicle 100, or portions thereof, at the time of last decoupling, as identified using information provided by the geospatial sensor 142. This geospatial information can be used to determine a precise location of the attachment 102 for future reattachment procedures. Such location information can also include recorded information obtained from the geographic sensor 140 regarding an angular orientation (e.g., height, tilt, pitch, roll, and/or yaw) and/or vertical height, among other information, of the attachment 102 and/or agricultural vehicle 100, or portions thereof, at the time of last decoupling. Such information can further assist in determining travel parameters for attaining a proper alignment between the agricultural vehicle 100 and the attachment 102, or portions thereof, including the first and second connection interfaces 110, 112, for coupling the agricultural vehicle 100 to the attachment 102.

The location database 170 can also include information regarding the settings of one or more actuators 148 when the attachment 102 was last decoupled from the agricultural vehicle 100. Such information can include parameters relating to the position, orientation, and/or state of the actuators 148 at the time the attachment 102 was last decoupled. These settings can provide information that can allow the actuators 148 to again attain such positioning, orientation, and/or states for a subsequent re-coupling of the attachment 102 to the agricultural vehicle 100, or other vehicle 100.

While the foregoing discussed information that can be stored in the attachment database 166, including the identification and location databases 168, 170, such information, or similar information, can also include one or more of the memory devices 126, 148.

FIG. 3 illustrates an exemplary representation of an agricultural vehicle 110 being separated from an attachment 102 by a plurality of relative position thresholds (e.g., X₁-X₅), each of which, in this example, can each represent a different distance between the agricultural vehicle 100 and the attachment 102. While the example shown in FIG. 3 is discussed with respect to relative position thresholds relating to distances, the relative position thresholds can relate to other factors that can be used to assess the position of the agricultural vehicle 110 relative to the attachment 102, including, for example, while the agricultural vehicle 110 is moving toward a generally stationary attachment 102. For example, according to certain embodiments, in addition to, or in lieu of distance, the relative position threshold can correspond to locations or positions as a function of time and/or time.

In the illustrated example shown in FIG. 3 in which the relative position thresholds correspond to distances, each relative position threshold, which can be predetermined, can coincide with the start of a different travel state (e.g., State₁-State₄). Thus, each travel state can extend between two successive relative position thresholds. Further, in such an example, the length or distance of each travel state between different relative position thresholds can decrease as each travel state successively gets closer to the attachment 102. However, according to other embodiments, the distance each travel state extends between successive relative position thresholds can generally be the same. Additionally, while FIG. 3 illustrates five relative position thresholds that correspond to four travel states, the number of relative position thresholds and travel states can vary.

The location and/or corresponding distance covered by each relative position threshold and/or travel state can be determined in a variety of different manners, and based on a variety of different factors. For example, according to certain embodiments, the locations and number of relative position thresholds and/or travel states can be determined by the machine learning model(s) of the neural network 162, as discussed above. Additionally, or alternatively, the locations, positions, and/or distances covered by the relative position thresholds and/or travel states can be at least partially based on operator preferences or settings, which the operator can provide to the controller 122 via use of the input device 148, and/or at least partially based on default settings, as also discussed above.

The location of each relative position threshold, and/or the corresponding distance covered by each travel state, can be used to operate the agricultural vehicle 100 according to associated travel parameters that are generally configured to align the agricultural vehicle 100 with the attachment 102 and/or position the first connection interface 110 for mating engagement with the second connection interface 112. Thus, such relative position thresholds can be utilized to determine when the agricultural vehicle 100 should transition from one travel state and/or travel parameters to another travel state and/or travel parameters. Thus, for example, upon satisfaction of a first relative position threshold (X₁), the movement of the agricultural vehicle 100 in connection with aligning the agricultural vehicle 100, or components thereof, to the attachment 102 can be at least based on one or more first travel parameters of a first travel state, and then, when the agricultural vehicle 100 subsequently satisfies a second threshold distance (X₂), be based on one or more second travel parameters of a second travel state.

A variety of parameters, and/or associated parameter tolerances, can be set and/or adjusted in connection with aligning the agricultural vehicle 100 with the attachment 102, including orienting the first connection interface 110 for mating engagement with the second connection interface 112, during an attachment process. For example, travel parameters can include a speed of travel, and/or heading, orientation of the agricultural vehicle 100, and/or orientation (e.g., height, tilt, pitch, roll, and/or yaw) of the first connection interface 110, as well as one or more associated tolerances for such parameters, among other parameters. Additionally, the travel parameters, including adjustments thereto, can be determined in a variety of different manners, and based on a variety of different factors. For example, according to certain embodiments, the travel parameters for one or more relative position thresholds can be determined by the machine learning model(s) of the neural network 162, as discussed above, including the use of information, including near-real time and/or updated information, provided by the sensor system 136. Additionally, the travel parameters for one or more travel states can be at least partially based on commands provided by an operator to the controller 122 via use of the input device 148 and/or at least partially based on default settings, as also discussed above.

The travel parameters can be different, including change, for different relative position thresholds and/or travel states. Such differences can include, for example, the number, types, and/or values, including tolerances, of the travel parameters. For example, for at least some travel states and/or relative position thresholds, the travel parameters can include one or more of a speed of travel, heading, and/or orientation of the agricultural vehicle 100. Additionally, or alternatively, for other travel states or corresponding relative position thresholds, the travel parameters can include parameters relating to the orientation (e.g., height, tilt, pitch, roll, and/or yaw) of the first connection interface 110, as well as one or more associated tolerances. The travel parameters for different travel states can be based on a variety of considerations, including, for example, the size and capabilities of agricultural vehicle 112. For example, the travel parameters for different travel states can be at least partially based on dimensions or measurements of the agricultural vehicle 112 (e.g., height, length, width, wheelbase) that can influence the speed, position, and/or steering of the agricultural vehicle 112 as the relative position of the agricultural vehicle 112 changes as the agricultural vehicle 112 moves toward or approaches the attachment 102.

According to certain embodiments, the travel parameters can, for at least some travel states and/or upon satisfaction of certain relative position thresholds, be automatically implemented, such as, for example, implemented via one or more signals generated by the controller 124 for operation of one or more of the guidance system 128, steering system 130, transmission system 132 and/or prime mover 134, among other components or systems of the agricultural vehicle 100. Additionally, or alternatively, at least some, if not all, of the determined travel parameters can be outputted to the output device 150, such as, for example, in response to one or more signals generated by the controller 122, as suggestions that an operator may, or may not, implement. Whether at least some, if not all, of the travel parameters are implemented during an attachment process can be based on operator settings. For example, as discussed below, in certain situations, operator settings can indicate that the travel parameters are to be automatically implemented until the agricultural vehicle 102 is within a certain distance of the attachment 102, at which point, the operator can, using or not using outputted suggested travel parameters, manually complete the attachment process via use of the input device 148.

In the example shown in FIG. 3, the illustrated first threshold distance (X₁) can correspond to the furthest distance of the relative position thresholds from the attachment 102, such as, for example, a distance of around 150 meters, among other distances, while the fifth threshold distance (X₅) is closest to the attachment 102. For example, the fifth threshold distance (X₅) can be about zero meters from the attachment 102. Moreover, in this example, the fifth threshold distance (X₅) can correspond to the agricultural vehicle 100 being at a location at which the first connection interface 110 can, via operation of the attachment actuator(s) 118, result in the first connection interface 110 matingly engaging, including, to the second connection interface 112, including via a coupling at the contact points 114, 116. Thus, each other relative position threshold (X₂, X₃, X₄) in this example can correspond to a different distance between the first and fifth relative position thresholds (X₁, X₅). Accordingly, in one non-limiting example, the second relative position threshold (X₂) can be around ten meters from the attachment 102, the third relative position threshold (X₃) can be around six meters from the attachment 102, and the fourth relative position threshold (X₄) can be around three meters from the attachment 102. Further, according to such an example, a first travel state can extend between the first and second relative position thresholds (X₁, X₂), a second travel state can extend between the second and third relative position thresholds (X₂, X₃), a third travel state can extend between the third and fourth relative position thresholds (X₃, X₄), and a fourth travel state can extend between the fourth and fifth relative position thresholds (X₄, X₅).

Each relative position threshold and/or travel state can facilitate a hierarchical approach to positioning and aligning the agricultural vehicle 100 and the first connection interface 110 with the attachment 102, including the second connection interface 112. Such an approach can allow for employing different travel parameters, as determined via at least the machine learning model(s), to transition from gross positioning, such as, for example, at least at a relatively remote distance(s) thresholds, to fine positioning via more precise alignment at one or more relative position thresholds that are in relatively close proximity to the attachment 102. Such an approach of more precisely refining the alignment of the agricultural vehicle 100 and first connection interface 110 as the agricultural vehicle 100 moves into closer proximity the attachment system 120 can provide an at least partially automated system 120 that relatively smoothly and accurately transitions the agricultural vehicle 100 and first connection interface 110 into proper alignment during the attachment process.

As also seen in the example provided by FIG. 3, the illustrated first travel state (State₁), given the first relative position threshold (X₁) is relatively far from the attachment 102. According to certain embodiments, the attachment system 120 can operate at default settings and/or under the control of the operator such that the agricultural vehicle 100 is generally guided toward the attachment 102, including, for example, by use of the guidance system 128 and knowledge of the general location of the attachment 102, as provided by the attachment database 166 and/or memory device 126, 158, the proximity sensor 144, and or visual identification by the operator. For example, according to certain situations in which the location of the attachment 102 was not recorded during the last decoupling operation, or the attachment 102 was subsequently moved to a different location, the proximity sensor 144, including, for example, a distance perception or vision system, can be utilized for the detection and recognition of at least a portion of the frame of the attachment 102, including, for example, the center frame, among other visual markers or indicators. In such a situation, the detected frame, or portion thereof, or other visual marker can be utilized to, at least initially, guide the travel of the agricultural vehicle 100 to the attachment 102.

Thus, in this example, the first travel state may not be associated with any particular travel parameters, including first travel parameters relating to the travel speed, heading, or alignment of the agricultural vehicle 100 as well as the orientation (e.g., height, tilt, pitch, roll and/or yaw) of the first connection interface 110. Instead, during the first travel state, a preliminary alignment of at least the agricultural vehicle 100 to the attachment 102 can occur, which may be guided by the recorded location of the attachment 102 and the location of the agricultural vehicle 102 as indicated by the geospatial sensor 142, information provided by the proximity sensor 144, and/or by manual steering by the operator. However, upon reaching the second relative position threshold (X₂) and/or entering the second travel state, the machine learning model(s) can, using information provided by the sensor system 136 (e.g., the geospatial sensor 142, geographic sensor 140, and/or proximity sensor 144), including at least near-real time information obtained by one or more sensors of the sensor system 136, be utilized to determine one or more second travel parameters. In such an embodiment, at least the second travel parameters can relate to generally coarse adjustment in the alignment of the agricultural vehicle 100 relative to the attachment 102, but not specifically directed to the orientation of the first connection interface 110. For example, according to certain embodiments, the second travel parameters can relate to one or more of the speed, heading, and alignment (e.g., approach or steering angles) of the agricultural vehicle 100 relative to the attachment 102, or portion thereof, including, for example, the center frame of the attachment 102 and or the position of the second connection interface 112. However, in such an example, the second travel state parameters may not include parameters relating to adjusting the orientation of the first connection interface 110, including, for example, the vertical height, tilt pitch, roll, and/or yaw of the first connection interface 110.

Upon reaching or passing the third relative position threshold (X₃), the machine learning model(s) can, using information provided by the sensor system 136 (e.g., the geospatial sensor 142, geographic sensor 140, and/or proximity sensor 144), including updated or at least near-real time information obtained by one or more sensors of the system 136, be utilized to determine one or more third travel parameters. Similar to the second travel parameters, in the illustrated example, the third travel parameters can relate to general adjustments of movement of the agricultural vehicle 100, but not specifically directed to the orientation of the first connection interface 110. However, at least some of the third travel parameters, or associated tolerances, can vary from similar travel parameters of the second travel parameters in an attempt to more closely and/or accurately bring the movement and/or alignment of the agricultural vehicle 100 closer to what the agricultural vehicle 100 is to have when at least the agricultural vehicle 100 is to be aligned relative to the attachment 102 when the first and second connection interfaces 110, 112 are to matingly engage. For example, as the distance between the agricultural vehicle 100 and attachment 102 is, and continues to decrease, upon the agricultural vehicle 100 reaching the third relative position threshold (X₃) and/or operating in the third travel state (State₃), the travel speed of the agricultural vehicle 100 can, compared to at least the second travel parameters, be decreased for the third travel parameters. Additionally, the third travel parameters can, compared to at least the second travel parameters, further refine the heading and vehicle alignment, and/or associated tolerances, so as to more accurately correspond to the heading and alignment that the agricultural vehicle 100 will eventually attain when the first connection interface 110 is to engage the second connection interface 112.

Upon reaching, or passing, the fourth relative position threshold (X₄) and/or the fourth travel state (State₄), information provided by the sensor system 136, including, for example, updated and/or near-real time information, can be used with the machine learning model(s) to identify fourth travel parameters. Similar to the third travel parameters, the fourth travel parameters can further refine, including adjusting, one or more of the travel parameters, including, associated tolerances, corresponding to the agricultural vehicle 100 being moved into alignment with the attachment 102. Moreover, compared to at least the third travel parameters, the fourth travel parameters can further refine one or more travel parameters, including associated tolerances, so as to further improve the accuracy of the alignment and or heading of the agricultural vehicle 100 so as to further ensure the agricultural vehicle 100 will be properly aligned with the attachment 102 when the first connection interface 110 is to engage the second connection interface 112. Additionally, as the fourth relative position threshold is closer to the attachment 102 than the third relative position threshold, the fourth travel parameters can include a further reduction in the travel speed of the agricultural vehicle 100.

Additionally, as the fourth relative position threshold corresponds to the agricultural vehicle being in closer proximity to the attachment 102, the fourth travel parameters can further include one or more parameters to adjust the orientation (e.g., vertical height, tilt pitch, roll, and/or yaw) of the first connection interface 110 such that the first connection interface 110 is generally moved into proper alignment for an upcoming engagement with the second connection interface 112. Such adjustments in the orientation of the first connection interface 110 can, in at least certain circumstances, be at least partially based on information obtained from the memory device 126, 158 and/or attachment database 166, including the location database 170, that can indicate the prior settings, including positioning, orientation, and/or states, of the actuation actuator(s) 118 such that such settings can be repeated for the re-engagement of the first connection interface 110 with the second connection interface 112, and moreover, reattachment of the attachment 102 to the agricultural vehicle 100. Additionally, or alternatively, the fourth travel parameters relating to the positioning of the first connection interface 110 can be based on, or adjusted, using a variety of information, including, for example, knowledge of the configuration or dimensions of the attachment 102 and corresponding second connection interface 112, as can be provided by the memory device 126, 158 and/or attachment database 166, including the identification database 168. Further, such orientation parameters for the fourth travel parameters can be at least partially determined using an identification of the location and/or orientation, including relative locations and/or orientations, of the second connection interface 112 that is obtained from one or more sensors of the sensor system 136, including, for example, the geospatial sensor 142, geographic sensor 140, and/or proximity sensor 144. Further, according to the illustrated embodiment, information provided by the sensor system 136, including at least near-real time information, including from one or more of the geospatial sensor 142, geographic sensor 140, and/or proximity sensor 144, in addition to, or in lieu of, historical information regarding settings for the attachment actuator(s) 118, can be determined, updated, and/or refined, using the above-discussed one or more machine learning model(s).

In the illustrated example, upon reaching the fifth relative position threshold (X₅), the agricultural vehicle 100 is to have reached a position at which the agricultural vehicle 100 is aligned with the attachment 102 such that the first connection interface 110 can be moved, via the attachment actuator 118, into engagement with the second connection interface 112. In such a situation, the fifth travel parameters can include parameters that seek to stop the travel of the agricultural vehicle 100 at a position at which the first connection interface 110 can be matingly coupled to the second connection interface 112. According to certain embodiments in which the attachment system 120 is to move the first connection interface 110 into engagement with the second connection interface 112, and moreover, couple the first and second connection interfaces 110, 112 along the first and second connection points 114, 116, the controller 122 can generate one or more commands to actuate the attachment actuator 118 such that the first connection interface 110 matingly engages the second connection interface 112.

Alternatively, according to other embodiments, the system 120 can have previously received information indicating that an operator preference has established that upon reaching the fifth relative position threshold, the operator is to operate at least the attachment actuator 118 to matingly engage the first connection interface 110 to the second connection interface 112. Additionally, or alternatively, according to certain embodiments, the operator preference can also include the fifth relative position threshold being a predetermined distance from the attachment 112 such that the operator can steer or move the agricultural vehicle 100 a final distance before the first connection interface 110 matingly engages the second connection interface 112. In such an embodiment, the final distance the operator is to move the agricultural vehicle 100 from the fifth relative position threshold can be predetermined, including based on a default setting or an operator preference. According to such embodiments, the controller 122 can generate one or more signals to notify the operator, such as, for example, via the output device 150, that the first connection interface 110 and/or agricultural vehicle is ready to be moved into engagement with the second connection interface 112. The controller 122 can further generate one or more signals to provide recommendations to the operator with respect to moving the agricultural vehicle 100 the final distance and/or operating the attachment actuator 118 to obtain the mating engagement between the first and second connection interfaces 110, 112. Such recommendations can be achieved in a manner similar to that discussed above with respect to determinations of at least the fifth travel parameters, and thus can be based on one or more, or a combination of, information provided by one or more sensors of the sensor system 136, the machine learning model(s), and/or recorded historical information, including information from the memory device 126, 158 and/or attachment database 166.

While the above example discusses at least the attachment system 120 being used to automatically operate the agricultural vehicle 100 using travel parameters based on satisfaction of at least some, if not all, of the travel thresholds, according to certain embodiments, the travel parameters generated by the attachment system instead can be provided to the operator as suggestions as the operator manually controls the movement and alignment of the agricultural vehicle 100. According to such an embodiment, the travel parameters generated by the attachment system 120 can be output, such as, for example, in response to one or more signals generated by the controller 122 on the output device 150.

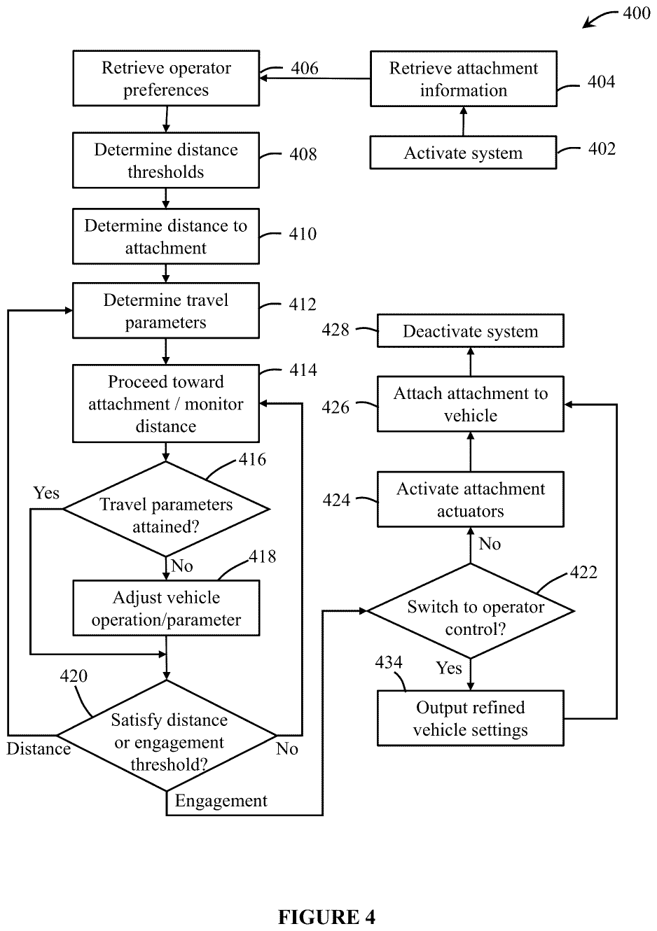

FIG. 4 illustrates a simplified exemplary representation of a method 400 involving control logic for the attachment system 120 in connection with aligning and attaching the first connection interface 110 of the agricultural vehicle 100 with the second connection interface 112 of the attachment 102. The method 400 corresponds to, or is otherwise associated with, performance of the illustrative sequence shown in, and described in connection with, FIG. 4, and can be carried out, for example, by the exemplary attachment system 120 shown in at least FIG. 2, including, for example, by one or more of the processors 124, 156 using at least information stored on one or more memory devices 126, 158. It should be appreciated, however, that the method 400 can be performed in one or more sequences different from the illustrative sequence. Additionally, the control logic mentioned below can include steps or processes other than, or in addition to, those discussed below.

At block 402, the attachment system 120 is activated, such as, for example, in response to a command inputted by an operator using the input device 148. At block 404, information regarding the attachment 102 that is to be coupled to agricultural vehicle 100 can be identified and/or retrieved, including, for example, by the controller 122 from the memory device 126, 158 or attachment database 166, including the identification database 168, as discussed above. This retrieval can, for example, involve querying the memory device 126, 158 to obtain stored parameters of attachment 102, or accessing the attachment database 166 to determine specific attributes of the attachment 102, including, for example, via inputting or capturing an identifier of the attachment 102. Additionally, the input device 148 can include a graphical user interface (GUI) that provides options for the operator to select the attachment 102 from a pre-defined list. According to certain embodiments, the identified attachment 102 can then be verified against parameters stored in identification database 168 to ensure compatibility with the agricultural vehicle 100, including with respect to the compatibility of the first and second connection interfaces 110, 112.

The information retrieved at block 404 can further include location and/or orientation information regarding the identified attachment 102 that is to be coupled to the agricultural vehicle 100 and/or regarding the agricultural vehicle 100 at the time the attachment 102 last underwent the detachment process. Such location and/or orientation information can be retrieved, for example, from memory device 126, 158 and/or the attachment database 166, including the location database 170, as discussed above. The information retrieved at block 404 can further include, to the extent available, information regarding the positioning, orientation, and/or state of the actuators 148 at the time the attachment 102 was last coupled to the agricultural vehicle 102, as can be provided, for example, for the memory device 126, 158 and/or the attachment database 166, including the location database 170, as discussed above.

At block 406, the controller 122 can retrieve one or more operator preferences, such as, for example, from the memory device 126, 158 or a database 164, 166. As previously discussed, such operator preferences can be considered, including used by the machine learnable model and/or controller 122, in the process of attaching the agricultural vehicle 100 to attachment 102. For example, according to certain embodiments, the operator can provide a preference, such as, for example, via use of the input device 148 or which has been stored by the memory device 126, 158 or historical database 164, regarding the extent the attachment process is to be automated or be controlled by the operator. For example, certain operators can prefer the attachment system 120 control, or handle, the entire attachment process autonomously, whereas operators can choose a semi-automated approach where the automated system 120 handles aligning the agricultural vehicle 100 to attachment 102 until the agricultural vehicle 100 is within a certain distance from the attachment 102, and/or until a particular operation is to occur in the attachment process. For example, as discussed above, the operator can establish a preference that the operator take control of the attachment process with respect to moving the first connection interface 110 into engagement with the second connection interface 112, as discussed above.

The attachment system 120 can obtain, or retrieve, a variety of other operator preferences at block 406, including, for example, speed preferences based on different relative position thresholds between the agricultural vehicle 100 and the attachment 102. For example, the operator can set different preferences for speed settings or thresholds as the agricultural vehicle 100 comes within certain relative position thresholds from the attachment 102. Such speed preferences can be tailored to the comfort level of the operator and/or the typical field conditions, among other experiences or knowledge of the operator.

The attachment system 120 can also obtain, or retrieve, operator preferences at block 406 relating to the alignment of the agricultural vehicle 100 and the attachment 102, and/or portions thereof, including, for example, an alignment between the first and second connection interfaces 110, 112. As with the speed settings, according to certain embodiments, such alignment preferences can relate to different tolerances regarding the orientations of the agricultural vehicle 100 and the attachment 102, and/or portions thereof, at different distances between the agricultural vehicle 100 and the attachment 102, including, for example with respect to different relative position thresholds between the agricultural vehicle 100 and the attachment 102. For example, the operator can provide preferences in which a wider range of misalignment between the agricultural vehicle 100 and the attachment 102 is acceptable at certain distances away from the attachment 102, and the extent such tolerances are to be lessened as the distance between the agricultural vehicle 100 and the attachment 102 decreases. Such preferences can thus relate to the aggressiveness of the attachment system 100 when making alignment adjustments, including adjustments that can be necessitated by differences in terrain characteristics at different distances from the attachment 102.

At block 408, one or more relative position thresholds and/or corresponding travel states, as well as the corresponding travel parameters can be determined. As previously discussed, the identification of the relative position thresholds, travel parameters, and/or travel states can be determined in a variety of manners, including using the one or more machine learning models, operator preferences, and/or default settings, as well as combinations thereof, among other manners. For example, when utilizing machine learning models of the neural network 162, the relative position thresholds can be dynamically determined based on historical information and at least near real-time information input from the sensor system 136, including from one or more of the geospatial sensor 142, geographic sensor 140, and/or proximity sensor 144, among others. According to such an embodiment, the machine learning model(s) can be based on recognized patterns from previous attachment procedures, including from information relating to prior attachment procedures stored in the historical database 164, and predict optimal relative position thresholds. Additionally, the machine learning models can be configured to refine the precision of the relative position thresholds by incorporating feedback information, such as the state and performance metrics of past attachment procedures.

As previously discussed, operator preferences, as captured through the input device 148, can also be utilized to define relative position thresholds. For example, operators can specify one or more relative position thresholds at which the operator will retain, including regain, manual control of the agricultural vehicle 100, as well as preferences for automated adjustments in alignment and speed. Further, an operator can set wider tolerances for travel of the agricultural vehicle 100 for larger distances away from the attachment 102 in a manner that can expedite at least the initial approach of the agricultural vehicle 102 to the attachment 102, and progressively narrow those tolerances for finer control, including adjustments in the speed, orientation, and/or alignment of the agricultural vehicle 100 relative to the attachment 102 as the vehicle 100 nears the attachment 102. Operators can also input preferred speeds and approach or steering angles, which, for example, can be based on operator comfort levels and/or field conditions that can be reflected in the generated travel parameters, as previously discussed.

Default settings can provide pre-defined relative position thresholds and associated travel states, which can, for example, be provided as a fallback when determinations from the machine learning model(s) is unavailable and/or when operator preferences are not specified. These defaults can be based on standard operational parameters for typical field conditions, vehicle, and attachment types. For example, a default first relative position threshold might be set at one-hundred fifty meters to begin gross alignment of the agricultural vehicle 100 to the attachment 102, a second threshold at fifteen meters for initial alignment adjustments for the agricultural vehicle 100, a third threshold at ten meters for refined alignment and reduced speed of travel for the agricultural vehicle 100, a fourth threshold at six meters for further precision of the agricultural vehicle 100 and/or first connection interface 110, and a final threshold at three meters to fine-tune the alignment of the agricultural vehicle 100 and/or first connection interface 110 and prepare for coupling.

At block 410, the distance between the agricultural vehicle 100 and the attachment 102 can be determined, including, for example, by the controller 122. According to certain embodiments, the distance between the agricultural vehicle 100 and the attachment 102 can be based at least in part on a current location of the agricultural vehicle location 100, as can be determined using information provided by the geospatial sensor 142. The distance can also be based at least on a recorded location of the attachment 102, or the recorded location at which the agricultural vehicle 100, or another vehicle, last decoupled from the attachment 102, as can be stored at the attachment database 166 or the associated location database 170 and/or by a memory device 126, 158. According to such an embodiment, a comparison of the current location or position of the agricultural vehicle 100 and the recorded last known location or position of the attachment 102, or associated location of the agricultural vehicle 100 when last decoupled from the attachment 102, can be used to determine the distance between the between the agricultural vehicle 100 and the attachment 102, or portions thereof. Alternatively, the distance between the agricultural vehicle 100 and the attachment 102, or portions thereof, can be determined using information provided by the proximity sensor 144.

The determination of the distance between the agricultural vehicle 100 and the attachment 102, as identified at block 410 can further be used in connection with the information obtained at block 408 to identify whether the agricultural vehicle 100 is at a location associated with, or which satisfies, at least one of the relative position thresholds. Moreover, such information can be utilized, such as, for example by the controller 122 and or via use of the machine learning model, to generate the corresponding, and above-discussed, travel parameters at block 412.

At block 414, the agricultural vehicle 100 can proceed with, or continue, moving towards the attachment 102. As previously discussed, such movement of the agricultural vehicle 100 can be based, at least in part, on the identified one or more parameters from block 412, which, may either be automatically implemented by the attachment system 120 by use of the controller 122, and/or provided as suggestions outputted to the operator via the output device 150. Additionally, as the agricultural vehicle 100 travels toward the attachment 102, the location of the agricultural vehicle 100 and/or the distance between the agricultural vehicle 100 and the attachment 102 can be generally continuously monitored and/or determined.

As the agricultural vehicle 100 is traveling, the controller 122 can determine, using information from one or more sensors of the sensor system 136, whether the one or more of the travel parameters is being satisfied, including being within a predetermined tolerance. Such a determination can include, for example, whether the agricultural vehicle 100 is within, or satisfies, a predetermined range, including tolerance, for alignment with the attachment 102. According to such an embodiment, if the controller 122 determines at block 416 that a travel parameter is not being satisfied, then at block 418, an operation of one or more of the guidance system 128, steering system 130, transmission system 132, and/or prime mover 134 can be adjusted. The extent or nature of such an adjustment can be determined in a variety of different manners, and can be at least partially based on the nature of the parameter(s) that is not being satisfied. For example, according to certain embodiments, near real-time information provided by the sensor system 136 can be applied to the machine learning model to attain an updated travel parameter(s), including, for example, an update to a travel parameter(s) that can adjust an operation of the guidance and/or steering system 128, 130 for adjusting the alignment, or lack thereof, that was being, or is to be, attained relative to the attachment 102.

At block 420, the controller 122 can, using information provided from at least block 414, as well as the relative position thresholds determined at block 408, determine whether the agricultural vehicle 100 has moved to a location at which another relative position threshold has been satisfied. If the controller 122 decides that block 416 that another relative position threshold has not been satisfied, the method 400 can return to block 414 wherein the at least the distance traveled by the agricultural vehicle 100 can continue to be monitored to determine when another relative position threshold is satisfied. If however, at block 420, the controller 122 determines that a relative position threshold has been satisfied, then the controller 122 can determine whether the satisfaction of another relative position threshold is the facilitate a change in the operation of the attachment system 120, including, for example, whether the alignment of the agricultural vehicle 100 and/or the first connection interface 110 is to continue to be operated automatically via the attachment system 120, or if control is to be taken by the operator. Moreover, optionally, attachment system 120 can be configured for the operator to be able to override the automated system 120 when the agricultural vehicle 100 is at any predefined distance from the attachment point, or, at any other time. Such a manual control option can be particularly beneficial for operators who may prefer a hands-on approach for at least the final alignment and coupling of the agricultural vehicle 100 to the attachment 102.

For example, FIG. 4 illustrates an exemplary scenario in which the operator preference can indicate that the movement of the agricultural vehicle 100 and any associated adjustments in the orientation of the first connection interface 112 are to occur automatically via operation of the attachment system 120 until the agricultural vehicle has reached a location, or satisfied a relative position threshold, at which the agricultural vehicle 100 is adjacent to, and aligned with, the attachment 102. For purposes of illustration, such a position is referred to in FIG. 4 as an engagement position, and can, with respect to the example shown in FIG. 3, can correspond to the fifth threshold distance (X₅). In this example, if at block 420 the controller 122 identifies that a relative position threshold has been satisfied, but that the satisfied relative position threshold does not correspond to the engagement position (e.g., fifth threshold distance (X₅)), the method 400 can return to block 412, wherein travel parameters can be identified and subsequently implemented that correspond to the next threshold distance and/or associated next travel state. However, in this example, if the controller 122 determines at block 422 that the satisfied relative position threshold corresponds to the engagement position (e.g., fifth threshold distance (X₅)), then at block 422, the controller 112 can refer to the operator preferences, including, for example, the preferences retrieved at block 406 to determine whether control of the attachment process is to be given to the operator.

In this example, if the controller 122 determines at block 422 that control is not to be given to the operator, and that automatic engagement of the first connection interface 110 to the second connection interface 112 is to be automated, and moreover, the automatically performed by the attachment system 120 then at block 424 the controller 122 can activate the attachment actuators 118. As previously discussed, in at least certain situations, such actuation of the attachment actuators 118 can involve refining an orientation, including, alignment, of the first connection interface 110 relative to the second connection interface 112. Additionally, as previously discussed, such activation of the attachment actuators 118, can involve reestablishing the attachment actuators 118 to the settings that the attachment actuators 118 were recorded as having when the attachment actuators were last attached to the attachment 102. Further, as also previously discussed, based on information provided by one or more sensors of the sensor system 136, one or more of the machine learning models can be utilized to refine the settings that are to be implemented by the attachment actuators in establishing the mating engagement of the first connection interface 110 with the second connection interface 112.

Alternatively, if the controller 122 determines at block 422 that control of the attachment process is to be given to the operator, then at block 434 the controller 122 can generate a signal to facilitate the determinations discussed above with respect to block 424 regarding settings for the attachment actuators 118 being outputted at the output device 150 for consideration by the operator. Moreover, rather than automatically implementing the settings retrieved, determined, and or refined at block 424, those settings can instead be provided to the operator via the output device 150 consideration by the operator to implement.

Activation of the attachment actuators 118 automatically, as discussed, for example, with respect to block 424, or manually via the operator, as discussed, for example, with respect to block 434, can, at block 426 result in the first and second connection interfaces 110, 112 being matingly engaged such that, at block 426, the attachment 102 is coupled to the agricultural vehicle 100. With the attachment 102 coupled to the agricultural vehicle 100 at block 426, the attachment system 120, or portions thereof, can be deactivated at block 428.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A method for coupling an agricultural vehicle to an attachment, the method comprising:
determining, by a controller for a first relative position threshold, a first travel parameter corresponding to a first guided movement to align the agricultural vehicle to the attachment;
implementing, in response to a satisfaction of the first relative position threshold, the first travel parameter;
determining, by the controller for a second relative position threshold, a second travel parameter corresponding to a second guided movement to align the agricultural vehicle to the attachment, the second travel parameter being different than the first travel parameter and further including an orientation parameter comprising one or more settings for an orientation of a first connection interface of the agricultural vehicle relative to a second connection interface of the attachment, the second relative position threshold being different than the first relative position threshold; and
implementing, in response to a satisfaction of the second relative position threshold, the second travel parameter, the implementation of the second travel parameter comprising adjusting the orientation of the first connection interface based at least on the orientation parameter,
wherein the one or more settings comprises a recorded actuator setting stored in a memory for one or more actuators corresponding to a prior positional relationship of the first connection interface relative to the second connection interface when the first connection interface was matingly engaged with, or detached from, the second connection interface, and
wherein the implementation of the second travel parameter further comprises refining the recorded actuator setting based on a sensor output from before or during the adjusting of the orientation of the first connection interface.

2. The method of claim 1, wherein at least one of the first travel parameter and the second travel parameter each includes at least one of a steering angle and an approach angle of the agricultural vehicle.

3. The method of claim 1, wherein at least one of the first travel parameter and the second travel parameter further comprises a speed of travel of the agricultural vehicle.

4. The method of claim 1, wherein the second travel parameter comprises a refinement of the first travel parameter with respect to at least one of a range and a tolerance of one or more parameters of the first and second travel parameters.

5. The method of claim 1, further comprising:
retrieving a prior location for at least one of the attachment and the agricultural vehicle, the prior location corresponding to a location at which the agricultural vehicle or another vehicle previously decoupled from the attachment; and
wherein the first and second relative position thresholds comprises a distance from the agricultural vehicle to the prior location.

6. The method of claim 1, wherein the recorded actuator setting is a setting of one or more attachment actuators of the agricultural vehicle, and wherein the refining of the recorded actuator setting is performed using a machine learning model.

7. The method of claim 1, wherein the first travel parameter does not include a parameter to adjust the orientation of the first connection interface using an attachment actuator.

8. The method of claim 1, further comprising determining at least one of the first travel parameter and the second travel parameter using information provided by a geographical sensor regarding a terrain on which the agricultural vehicle is traveling.

9. The method of claim 1, wherein determining the first relative position threshold comprises determining by the controller the first relative position threshold using a machine learning model of a neural network, and wherein determining the second relative position threshold comprises determining by the controller the second relative position threshold using the machine learning model of the neural network.

10. The method of claim 1, further comprising adjusting at least one of the first travel parameter and the second travel parameter based on an operator preference.

11. A method for coupling an agricultural vehicle to an attachment, the method comprising:
(a) determining, by a controller, a travel parameter for each relative position threshold of a plurality of relative position thresholds, each relative position threshold of the plurality of relative position thresholds corresponding to a different relative position between the agricultural vehicle and the attachment, the travel parameter for one or more relative position thresholds of the plurality of relative position thresholds being different than the travel parameter for at least another relative position threshold of the plurality of relative position thresholds, the travel parameter for at least one relative position threshold of the plurality of relative position thresholds further comprising an orientation parameter comprising one or more settings for an orientation of a first connection interface of the agricultural vehicle relative to a second connection interface of the attachment;
(b) implementing, in response to a satisfaction of a relative position threshold of the plurality of relative position thresholds, the travel parameter of the relative position threshold determined to be satisfied, the travel parameter for one or more of the relative position thresholds refining the travel parameter for one or more other relative position thresholds that correspond to a larger variance in the relative positions of the agricultural vehicle and the attachment;
(c) repeating step (b) for each relative position threshold of the plurality of relative position thresholds; and
(d) adjusting the orientation of the first connection interface in response to the at least one relative position threshold being determined to be satisfied, based at least on the orientation parameter,
wherein the one or more settings comprises a recorded actuator setting stored in a memory for one or more actuators corresponding to a prior positional relationship of the first connection interface relative to the second connection interface when the first connection interface was matingly engaged with, or detached from, the second connection interface, and
wherein step (d) further comprises refining the recorded actuator setting based on a sensor output from before or during the adjusting of the orientation of the first connection interface.

12. The method of claim 11, further comprising determining, for each relative position threshold of the plurality of relative position thresholds, the satisfaction of the relative position threshold.

13. The method of claim 11, wherein the at least one relative position threshold of the plurality of relative position thresholds comprises less than all of the plurality of relative position thresholds.

14. The method of claim 11, wherein the recorded actuator setting is a setting of one or more attachment actuators of the agricultural vehicle, and wherein the refining of the recorded actuator setting is performed using a machine learning model.

15. The method of claim 11, further comprising:
retrieving a prior location for at least one of the attachment and the agricultural vehicle, the prior location corresponding to a location at which the agricultural vehicle or another vehicle previously decoupled from the attachment; and
wherein each relative position threshold of the plurality of relative position thresholds comprises a different distance from the agricultural vehicle to the prior location.

16. A system for coupling an agricultural vehicle to an attachment, the system comprising:
an attachment actuator to adjust an orientation of a first connection interface of the agricultural vehicle;
a guidance system and a steering system, the steering system configured to execute a guidance directive determined by the guidance system;
a sensor system configured to provide a sensor output indicative of at least a position or orientation of the first connection interface relative to a second connection interface of the attachment;
a memory device coupled to at least one processor, the memory device including instructions that when executed by the at least one processor cause the system to:
determine, for a first relative position threshold, a first travel parameter corresponding to a first guided movement using the guidance system and the steering system to align the agricultural vehicle to the attachment;
implement, in response to a satisfaction of the first relative position threshold, the first travel parameter;
determine, for a second relative position threshold, a second travel parameter corresponding to a second guided movement using the guidance system and the steering system to align the agricultural vehicle to the attachment, the second travel parameter being a refinement of at least one parameter of the first travel parameter with respect to at least one of a value and a tolerance of the at least one parameter, the second travel parameter further including an orientation parameter comprising one or more settings for the orientation of the first connection interface relative to the second connection interface of the attachment, the second relative position threshold being different than the first relative position threshold; and
implement, in response to a satisfaction of the second relative position threshold, the second travel parameter, the implementation of the second travel parameter comprising an adjustment, using the attachment actuator, of the orientation of the first connection interface based at least on the orientation parameter,
wherein the one or more settings comprises a recorded actuator setting stored in the memory device for one or more actuators corresponding to a prior positional relationship of the first connection interface relative to the second connection interface when the first connection interface was matingly engaged with, or detached from, the second connection interface, and
wherein the implementation of the second travel parameter further comprises refining the recorded actuator setting based on the sensor output from before or during the adjustment of the orientation of the first connection interface.

17. The system of claim 16, wherein the sensor system comprises a proximity sensor configured to provide information indicative of a position or a distance of the attachment relative to the agricultural vehicle, and wherein the memory device further includes instructions that when executed by the at least one processor cause the system to determine the satisfaction of the first relative position threshold.

18. The system of claim 16, wherein the at least one parameter of the first travel parameter comprises one or more of a steering angle and an approach angle of the agricultural vehicle.

19. The system of claim 16, wherein the first travel parameter comprises a speed of travel of the agricultural vehicle.

20. The system of claim 16, wherein the memory device further includes instructions that when executed by the at least one processor cause the system to retrieve a prior location for at least one of the attachment and the agricultural vehicle, the prior location corresponding to a location at which the agricultural vehicle or another vehicle previously decoupled from the attachment, and
wherein the first and second relative position thresholds each comprises a distance from the agricultural vehicle to the prior location.
